(19) United States
(12) Patent Application Publication
(10) Pub. No.: US 2013/0044565 A1
(43) Pub. Date: Feb. 21, 2013

(54) PIEZOELECTRIC SENSORS FOR GEOPHYSICAL STREAMERS

(71) Applicants: FREDERICK JAMES BARR, Pearland, TX (US); Stig Rune Lennart Tenghamn, Katy, TX (US); Anders Göran Mattsson, Lysaker (NO)

(72) Inventors: FREDERICK JAMES BARR, Pearland, TX (US); Stig Rune Lennart Tenghamn, Katy, TX (US); Anders Göran Mattsson, Lysaker (NO)

(21) Appl. No.: 13/209,909

(22) Filed: Aug. 15, 2011

(51) Int. Cl. G01V 1/38; H04R 17/00

(52) U.S. Cl. 367/20; 367/167; 367/21

(57) ABSTRACT

A disclosed digital sensor includes a pair of piezoelectric sensors that respond to acceleration and pressure in opposite ways, a pair of digital transducer circuits each employing a quantized feedback path to obtain digital sensor signals for the piezoelectric sensors, and a combiner circuit that combines the digital sensor signals to produce a compensated digital output signal. The compensated digital output signal may be a pressure compensated acceleration signal, an acceleration compensated pressure signal, or both. Also disclosed is a signal detection method that includes configuring a pair of piezoelectric membranes in a piezoelectric sensor to respond to acceleration and pressure in opposite ways, and based on their responses, producing at least one of a digital pressure compensated acceleration signal and a digital acceleration compensated pressure signal. The digital signals may be produced in part by applying a quantized feedback signal to at least one of the piezoelectric membranes.

### BACKGROUND

In the field of geophysical prospecting, the knowledge of the subsurface structure of the earth is useful for finding and extracting valuable mineral resources such as oil and natural gas. A well-known tool of geophysical prospecting is a “seismic survey.” In a seismic survey, acoustic waves produced by one or more sources are transmitted into the earth as an acoustic signal. When the acoustic signal encounters an interface between two subsurface strata having different acoustic impedances, a portion of the acoustic signal is reflected back to the earth's surface. Sensors detect these reflected portions of the acoustic signal, and outputs of the sensors are recorded as data. Seismic data processing techniques are then applied to the collected data to estimate the subsurface structure. Such surveys can be performed on land or in water.

In a typical marine seismic survey, multiple streamer cables are towed behind a vessel. A typical streamer includes multiple seismic sensors positioned at spaced intervals along its length. Several streamers are often positioned in parallel over a survey region. One or more seismic sources are also normally towed behind the vessel.

The signals received by sensors in marine streamers are contaminated with noise to varying degrees. This noise typically has many different origins. One major source of noise is “tow noise” resulting from pressure fluctuations and vibrations created as the streamer is pulled through the water by the vessel.

Currently, one of the main techniques used to reduce tow noise involves grouping adjacent sensors and hard-wiring the outputs of the sensors in each group together to sum their respective analog output signals. A typical sensor group contains eight to sixteen spaced apart sensors. Each group may span between 10 and 20 meters. Since the individual sensors in each group are fairly closely spaced, it is assumed that all the sensors in a given group receive substantially the same seismic signal. The seismic signal is therefore reinforced by the summing of the analog output signals of the hydrophones of the group and the particle motion sensors of their corresponding group. Random and uncorrelated noise affecting each sensor, on the other hand, tends to be cancelled out by the summing process. The gain of eight to sixteen over the output of an individual sensor provides quite good rejection of random noise.

### BRIEF DESCRIPTION OF THE DRAWINGS

A better understanding of the various disclosed embodiments can be obtained when the detailed description is considered in conjunction with the attached drawings, in which:

FIG. 1 is a side elevation view of an illustrative embodiment of a marine geophysical survey system performing a seismic survey;

FIG. 2 is a top plan view of the marine geophysical survey system of FIG. 1;

FIG. 3 is a schematic representation of an illustrative marine streamer section;

FIG. 4 is a diagram of a first illustrative sensor unit having a single digital sensor;

FIG. 5 is a diagram of a second illustrative sensor unit having multiple digital sensors;

FIG. 6 is a block diagram of an illustrative digital piezoelectric sensor;

FIG. 7 is a diagram of an illustrative piezoelectric sensing element;

FIG. 8 is a diagram of an illustrative sensor configuration for compensated measurements;

FIG. 9 is a diagram of an illustrative signal combiner unit;

FIG. 10 is a diagram of the illustrative compensated sensor configuration subject to a pressure stimulus;

FIG. 11 is a diagram of the illustrative sensor configuration subject to an acceleration stimulus;

FIG. 12 is a diagram of a portion of an alternate embodiment of the digital sensor of FIG. 8 configured to produce an acceleration compensated pressure signal;

FIG. 13 is a diagram of a portion of the embodiment of the digital sensor of FIG. 12 configured to produce a pressure compensated acceleration signal; and

FIG. 14 is a flow diagram of an illustrative geophysical survey method.

It should be understood that the drawings and detailed description do not limit the disclosure, but on the contrary, they provide the foundation for understanding all modifications, equivalents, and alternatives falling within the scope of the appended claims.

### DETAILED DESCRIPTION

At least some of the noise affecting the sensors in marine seismic streamers is not truly random and uncorrelated. For example the sensor noise created by the “thrumming” of the streamers is correlated between sensors. As a result, the summing of the analog output signals of multiple adjacent sensors in groups may not be very effective in reducing such noise. Such problems may be at least partly addressed by acquiring individual sensor data from the sensor units without incurring excessive power demands.

Accordingly, there is disclosed herein a digital sensor including a pair of piezoelectric sensors configured to respond similarly to acceleration and oppositely to pressure, a pair of digital transducer circuits each employing a quantized feedback path to obtain a digital sensor signal for a respective one of the piezoelectric sensors, and a combiner circuit configured to combine the digital sensor signals. The combiner circuit produces one or more digital output signals that represent pressure compensated acceleration and/or acceleration compensated pressure.

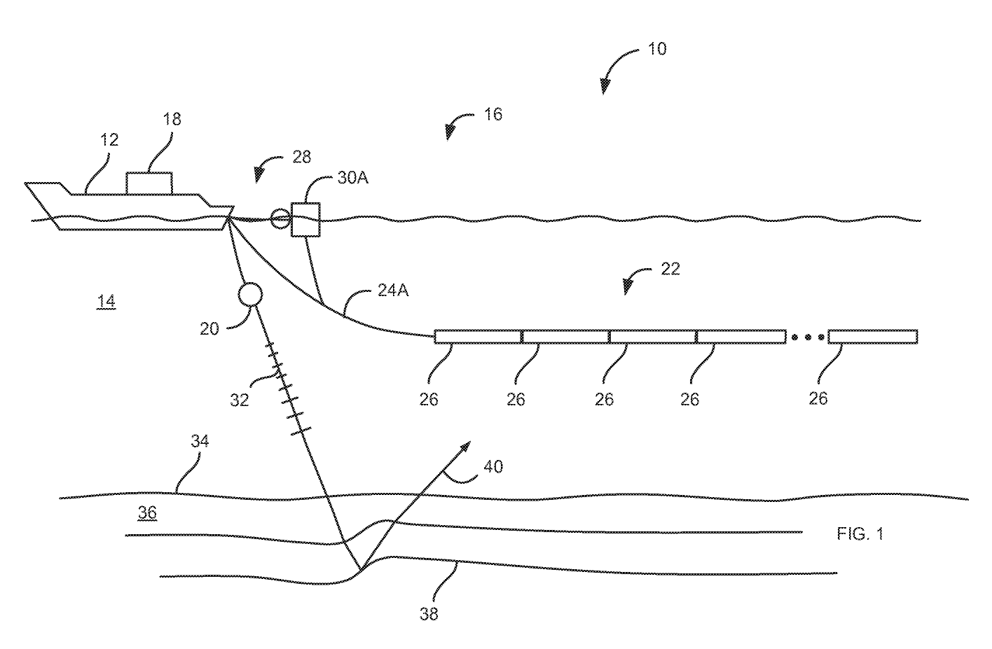

The principles and operation of the disclosed embodiments are best understood in a suitable usage context. Accordingly, FIG. 1 shows a side elevation view of an illustrative marine geophysical survey system 10 performing a marine seismic survey. A survey vessel or ship 12 moves along the surface of a body of water 14, such as a lake or an ocean, transporting a data acquisition system 16 that includes a data recording system 18 aboard the ship 12. The data acquisition system 16 also includes a seismic source 20 and a sensor array 22 towed through the water 14 by the ship 12.

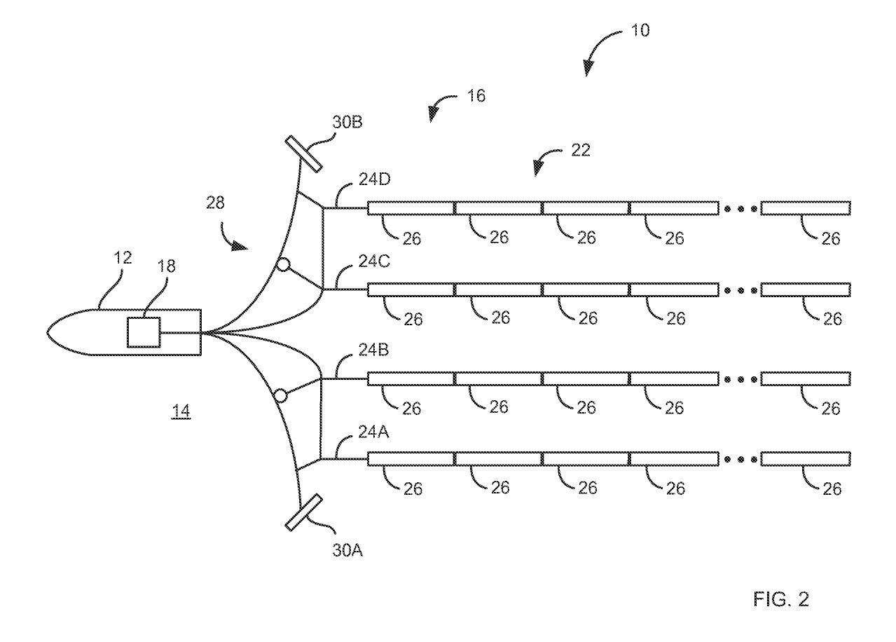

As illustrated in FIG. 2 and described in more detail below, the sensor array 22 includes one or more streamers having multiple spaced apart sensor units. Each sensor unit includes one or more sensors that detect seismic signals and produce digital output signals indicative of the seismic signals. The sensor units of the sensor array 22 span a two-dimensional area, with position sensors included to track the motion and configuration of the sensor array. A data recording system 18 collects and stores data from the sensor units.

FIG. 2 is a top plan view of the marine geophysical survey system 10 showing four sensor cables or streamers 24A-24D in the sensor array 22. Herein below, the streamers 24A-24D will be referred to collectively as the streamers 24. Each of the streamers 24 includes multiple streamer sections 26 connected end to end. Each of the streamer sections 26 includes multiple sensor units. The streamers 24 are towed via a harness 28 that produces a desired arrangement of the streamers 24. The harness 28 includes multiple interconnected cables and a pair of paravanes 30A and 30B connected to opposite sides of the harness 28. As the ship 12 tows the harness 28 through the water 14, the paravanes 30A and 30B pull the sides of the harness 28 in opposite directions, transverse to a direction of travel of the ship 12. The illustrated harness 28 is merely one possible design—many other harness designs are known and would also be suitable. Electrical conductors and/or fiber optic cables connect the sensor units in the streamer sections 26 of the streamers 24 to the data recording system 18 aboard the ship 12.

Referring back to FIG. 1, the seismic source 20 produces acoustic waves 32 under the control of the data recording system 18. The seismic source 20 may be or include, for example, an air gun, a vibrator, or other device. The acoustic waves 32 travel through the water 14 and into a subsurface 36 below a bottom surface 34. When the acoustic waves 32 encounter changes in acoustic impedance (e.g., at boundaries or layers between strata), portions of the acoustic waves 32 are reflected. The portions of the acoustic waves 32 reflected from subsurface layers are called “seismic reflections.” In FIG. 1, one such seismic reflection is shown from an interface 38 and labeled “40.”

As described in more detail below, sensor units of the sensor array 22, housed in the streamer sections 26 of the streamers 24, detect these seismic reflections and produce output signals indicative of the seismic reflections. The output signals produced by the sensor units are recorded by the data recording system 18 aboard the ship 12. The recorded signals are later processed and interpreted to infer structure of, fluid content of, and/or composition of rock formations in the subsurface 36. The streamer sections 26 of the streamers 24 may be substantially identical and interchangeable. This is advantageous in that if there is a problem with one of the streamer sections 26, the problematic streamer section 26 can be replaced by any other spare streamer section 26.

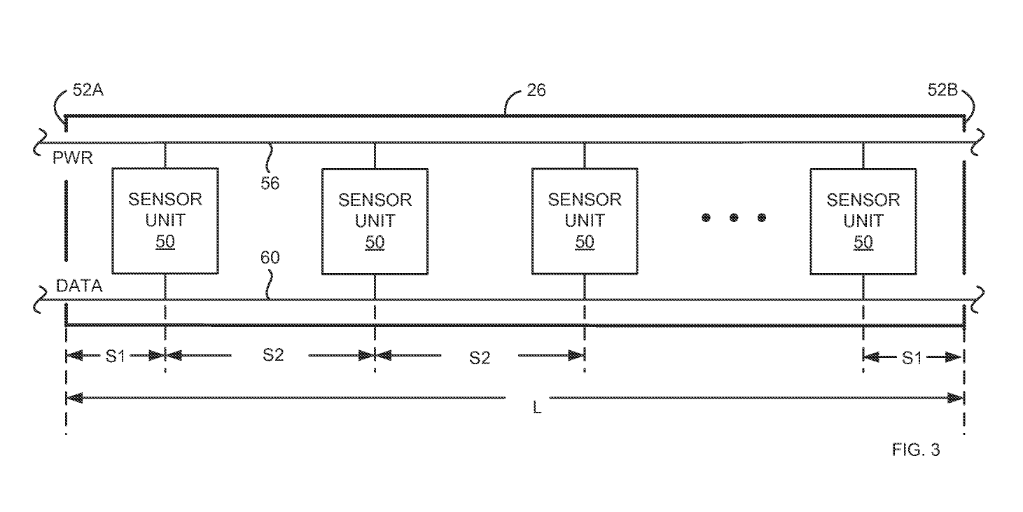

FIG. 3 shows an illustrative embodiment of one of the streamer sections 26 of the streamers 24 of FIGS. 1 and 2. In the embodiment of FIG. 3, the streamer section 26 includes multiple spaced apart sensor units 50, where each of the sensor units 50 includes at least one seismic sensor as described in more detail below. The streamer section 26 may be substantially cylindrical, and has two opposed ends 52A and 52B. The streamer section 26 has a length L, where L is expected to be between about 164 feet (50 meters) and 328 feet (100 meters), with sensor unit spacings of Si from the ends 52A, 52B, and spacings of S2 from each other, where S1 and S2 are each expected to be less than 4.9 feet (1.5 meters). In some embodiments S2 may lie in the range between 4 inches (10 cm) and 40 inches (100 cm), or in the narrower range between 7 inches (18 cm) and 14 inches (36 cm). Each of the ends 52A and 52B has one or more connectors for electrical power and data signals.

In at least some streamer embodiments, the sensor units 50 are partitioned into groups of N sensor units, where N is preferably between about 4 and approximately 64. When grouped, the sensor units 50 in each group are connected to a common group control unit. Each group control unit may receive digital data signals from the corresponding sensor units 50, and produce a single output data stream that conveys the data from the group. The output data stream may be produced using, for example, data compression techniques, time division multiplexing techniques, and/or frequency division multiplexing techniques.

In the embodiment of FIG. 3, a power distribution bus 56 and a data bus 60 span the length of the streamer section 26 between the one or more connectors at the ends 52A and 52B. Each of the sensor units 50 within the streamer section 26 is coupled to the power distribution bus 56 and the data bus 60. The power distribution bus 56 includes electrical conductors for providing electrical power to the sensor units 50. The data bus 60 includes electrical conductors and/or fiber optic cables for conveying output data streams produced by the sensor units 50. The data bus 60 is also used to convey output data streams produced by other sensor units within other streamer sections connected to the end 52B.

In the embodiment of FIG. 3, the end 52A of the streamer section 26 is closest to the data recording system 18 aboard the ship 12, and the output data streams produced by the sensor units 50 within the streamer section 26 are conveyed out of the streamer section 26 via electrical conductors and/or fiber optic cables of the data bus 60 terminating at the one or more connectors at the end 52A. Additional electrical conductors and/or fiber optic cables of the data bus 60 extend between the one or more connectors at the end 52B and the one or more connectors at the end 52A to convey output data streams produced by other sensor units within other streamer sections connected to the end 52B.

The streamer section 26 of FIG. 3 includes a jacket covering an exterior, and one or more strength members extending along the length of the streamer sections 26 inside the jacket. Suitable streamer section construction techniques are described in U.S. Pat. No. 7,298,672 granted to Tenghamn et al., incorporated herein by reference in its entirety. Other streamer design and construction techniques are also known and can be used.

Electrical power requirements and streamer weight often limit a number of sensors that can be located in streamer sections. As the number of sensors in a system increases, the power requirement of the system also increases. The weights of the streamers increase due not only to the increased number of sensors, but also to the required increase in the number and cross-sectional areas of the metallic conductors providing the electrical power to the sensors. Streamer weight is an issue because each streamer must be designed so that it is neutrally buoyant when submerged in water.

In some streamer embodiments, the power distribution bus 56 may be replaced by, or augmented by, a battery power supply system and/or an energy harvesting system. Thus the streamer section 26 may include one or more batteries that provides some or all of the power requirements of the sensor units 50. Streamer section 26 may alternatively, or in addition, include one or more energy harvesting devices that convert vibratory motion of the streamer section 26 into electrical power. As the streamer section 26 is towed through the body of water 14, the streamer section 26 expectedly experiences vibratory motion from a number of sources including vortex shedding, drag fluctuation, breathing waves, and various flow noise sources including turbulent boundary layers. Electrical energy produced by the energy harvesting system may provide some or all of the power requirements of the sensor units 50. Use of the battery power supply system and/or an energy harvesting system would expectedly reduce the number and/or cross sectional areas of the conductors of the power distribution bus 56.

Embodiments of an illustrative sensor unit 50 including one or more digital sensors are described below. Due at least in part to a digitization process with a quantized feedback signal path to the sensing element, the disclosed digital sensors may have substantially reduced size, weight, and power requirements compared to conventional sensors. At least some digital sensor embodiments may advantageously include micromachined components with miniature moving mechanical structures. Micromachining creates intricate and precisely patterned structures on relatively thick substrates through either bulk or surface processing technologies. Bulk micromachining sculpts moving pieces by removing material from the substrates. Surface micromachining involves depositing and subsequently etching thin films on the substrates, akin to common integrated circuit manufacturing processes. Both technologies produce physically smaller sensors that typically weigh less and dissipate less electrical energy. As explained further below, the integrated digitization circuit further reduces energy consumption as compared to an analog sensor followed by a separate analog-to-digital converter. The usage of such digital sensors in a streamer makes it possible to have an increased number of sensors while maintaining or reducing overall power and wiring requirements for the streamer.

The use of the disclosed digital sensors enables significantly more sensor units to be positioned in each streamer section 26 (FIGS. 1-3), and consequently enables the spacing distances S1 and S2 to be reduced. The data obtained from the sensor array 22 with more closely spaced sensor units 50 may advantageously enable the development and use of better noise attenuation algorithms.

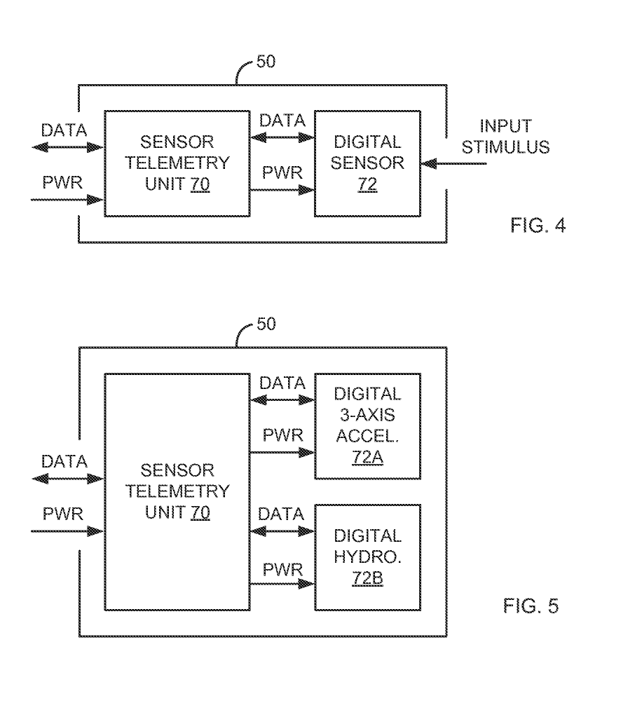

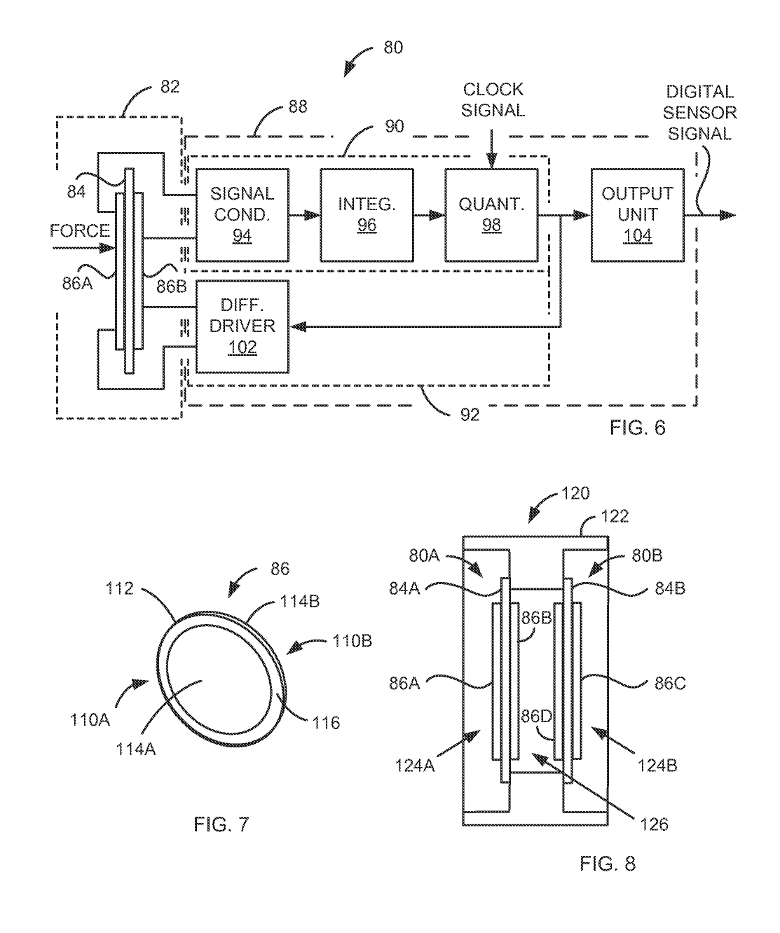

FIG. 4 shows an illustrative embodiment of sensor unit 50 of the streamer section 26 of FIG. 3. In the embodiment of FIG. 4, the sensor unit 50 includes a sensor telemetry unit 70 coupled to a digital sensor 72. As described below with reference to FIG. 6, the digital sensor 72 includes a quantized feedback loop and uses the quantized feedback loop to produce a digital output signal indicative of seismic wave energy. A sensing element of the digital sensor attempts to move or deform in response to an input stimulus (e.g., pressure or acceleration). When the sensing element receives no input stimulus, the quantized feedback loop causes the sensing element to oscillate symmetrically around a zero-input or “null” position or state of deformation. The resulting quantized signal (which is a pulse density modulated signal) is a series of evenly-spaced pulses. The quantized feedback loop converts the quantized signal into a quantized restoring force that causes the sensing element to oscillate around the null position. In the presence of input stimuli, the center of oscillation tends to move away from the null position, but the quantized feedback loop responsively adjusts the quantized restoring force to minimize this deviation. The sensing element may include, for example, piezoelectric discs. This sensor design requires no separate analog-to-digital conversion step.

In the embodiment of FIG. 4, the sensor telemetry unit 70 is coupled to the power distribution bus 56 and to the data bus 60 of FIG. 3, and provides electrical power from the power distribution bus 56 to the digital sensor 72. The sensor telemetry unit 70 receives control signals from the data recording system 18 (see FIGS. 1-2) via the data bus 60, and issues control signals to the digital sensor 72. The sensor telemetry unit 70 also receives the digital output signal produced by the digital sensor 72, and provides an output data stream that include a representation of the digital sensor output signal to the data recording system 18 via the data bus 60.

FIG. 5 shows an illustrative sensor unit 50 having multiple digital sensors. In the embodiment of FIG. 5, the sensor unit 50 includes the sensor telemetry unit 70 coupled to a digital 3-axis accelerometer 72A and a digital hydrophone 72B. The digital 3-axis accelerometer 72A provides measurements of acceleration in three orthogonal directions, and the digital hydrophone 72B provides measurements of pressure within a surrounding fluid. The digital 3-axis accelerometer 72A includes a quantized feedback loop for each sensing element, and it produces three digital output signals indicative of the sensor unit's motion along three axes, including motion due to seismic wave energy. The digital hydrophone 72B also includes one or more quantized feedback loops that cooperate with the sensing element to produce a digital output signal indicative of pressure within the surrounding fluid, including changes in pressure due to seismic wave energy. One or more sensing elements within the digital 3-axis accelerometer 72A and the digital hydrophone 72B move or deform in response to an input stimulus (e.g., acceleration or pressure).

FIG. 6 is a diagram of an illustrative digital piezoelectric sensor 80. The digital piezoelectric sensor 80 employs a quantized feedback loop 92 to produce a digital output signal. The illustrated piezoelectric sensor 80 includes a sensing element 82 coupled to a digital transducer circuit 88. The digital transducer circuit 88 includes forward circuitry 90, a quantized feedback loop 92, and an output unit 104. A signal conditioning unit 94, an integrator unit 96, and a quantizer unit 98 form parts of the forward circuitry 90. A differential driver unit 102 resides in the quantized feedback loop 92.

In the embodiment of FIG. 6, the sensing element 82 includes a pair of piezoelectric sensing elements 86A and 86B mounted on opposite sides of a flexible conductive sheet 84. The piezoelectric sensing elements 86A and 86B will be referred to collectively as piezoelectric sensing elements 86. FIG. 7 shows a perspective view of a representative one of the substantially identical piezoelectric sensing elements 86 of FIG. 6. In the embodiments of FIGS. 6 and 7, each of the piezoelectric sensing elements 86 has two opposed major surfaces 110A and 110B, referred to collectively as major surfaces 110. Each of the piezoelectric sensing elements 86 develops an electrical voltage between the opposed major surfaces 110 when deformed. In addition, when an electrical voltage is applied between the opposed major surfaces 110, the piezoelectric sensing elements 86 deform in response.

Referring to FIG. 7, the body 112 of each of the piezoelectric sensing elements 86 includes a piezoelectric material. Suitable piezoelectric materials include piezoelectric ceramics such as barium titanate, lead zirconate, and/or lead titanate, and piezoelectric crystals such as gallium phosphate, quartz, and tourmaline. In the embodiment if FIG. 7, the body 112 is a flat, circular disk having a substantially uniform thickness. The body 112 may be, for example, sliced from a much larger cylindrical piece of piezoelectric material.

Each of the piezoelectric sensing elements 86 of FIGS. 6 and 7 has a thickness that gives it sufficient strength to withstand expected hydrostatic pressures, yet enough flexibility to deform sufficiently in an acoustic pressure field to generate adequate electrical signals. Each of the piezoelectric sensing elements 86 may have a thickness of, for example, about 0.015 inches (0.381 millimeter). Suitable piezoelectric sensing elements 86 are commercially available, and some examples are described in U.S. Pat. No. 3,832,762 to Johnston et al., incorporated herein by reference in its entirety.

Referring to FIG. 7, a conductive electrode 114A is formed on the major surface 110A, and a similar conductive electrode 114B is formed on the major surface 110B. The conductive electrodes 114A and 114B will be referred to collectively as conductive electrodes 114. Suitable materials for the conductive electrodes 114 include metals such as gold, nickel, platinum, and/or rhodium. In the embodiment of FIG. 7, an optional border 116 is left between the periphery of each of the conductive electrodes 114 and a periphery of the body 112 to prevent short circuiting of the conductive electrodes 114 (e.g., by arcing).

Referring to FIG. 6, The flexible conductive sheet 84 is normally substantially planar, and may be constructed of any suitable electrically conductive material such as, for example, brass, beryllium, copper, phosphor bronze, or other copper alloy metal. The flexible conductive sheet 84 has a thickness that gives it sufficient strength to withstand expected hydrostatic pressures, yet deform sufficiently in an acoustic pressure field to generate adequate electrical signals. A thickness of about 0.016 inches (0.406 millimeters) is believed to be suitable.

As indicated in FIG. 6, one of the conductive electrodes 114 (see FIG. 7) on one of the major surfaces 110 (see FIG. 7) of the piezoelectric sensing element 86A is electrically coupled to one side of the flexible conductive sheet 84, and one of the conductive electrodes 114 on one of the major surfaces 110 of the piezoelectric sensing element 86B is electrically coupled to an opposite side of the flexible conductive sheet 84. The major surfaces 110 of the piezoelectric sensing elements 86A and 86B that are electrically coupled to the flexible conductive sheet 84 are also electrically coupled to each other. The major surfaces 110 of the piezoelectric sensing elements 86 may be mounted to, and/or electrically coupled to, opposites sides of the flexible conductive sheet 84 by, for example, soldering, or the use of an electrically conductive adhesive material such as an electrically conductive epoxy.

The flexible conductive sheet 84 rests in a zero-input or “null” position of deformation of the sensing element 82. When an external mechanical force acts on the a flexible conductive sheet 84 as indicated in FIG. 6, the flexible conductive sheet 84 bends, deforming the piezoelectric sensing elements 86 and causing the piezoelectric sensing elements 86 to generate a differential voltage signal between the conductive electrodes 114 (see FIG. 7) on the major surfaces 110 not coupled to the flexible conductive sheet 84. The sensing element 82 produces the differential voltage signal as an output signal.

The signal conditioning unit 94 receives the output signal produced by the sensing element 82 as an input signal, and modifies or alters the input signal to produce an output signal that facilitates subsequent integration of the output signal by the integrator unit 96. The signal conditioning unit 94 may, for example, convert a voltage signal to a current signal, convert a current signal to a voltage signal, amplify the input signal, attenuate the input signal, filter the input signal, and/or shift a direct current (DC) level of the input signal.

The integrator unit 96 receives the output signal produced by the signal conditioning unit 94 as an input signal, and integrates the input signal over time to produce an output signal. The integrator unit 96 may, for example, perform first-order low-pass filter operation on the input signal. The input signal to the integrator unit 96 is indicative of a current position or state of deformity of the sensing element 82. The output signal produced by the integrator unit 96 is indicative of a cumulative sum of the position or state of deformity of the sensing element 82 over time.

The quantizer unit 98 receives the output signal produced by the integrator unit 96 as an input signal, and a clock signal (e.g., from the sensor telemetry unit 70 of FIGS. 4 and 5) as a control input. The quantizer unit 98 maps the input signal to one of multiple digital output states. When the control signal is active (or asserted), the quantizer unit 98 generates a digital output signal corresponding to the digital state. The quantizer unit 98 continues to provide the same digital output signal when the control signal is not active (or deasserted). The one or more digital output signals are thus updated every cycle of the clock signal.

In some embodiments, the quantizer unit 98 may be a voltage comparator followed by a latch, forming what might be referred to as a 1-bit analog-to-digital converter (ADC). The voltage comparator receives the output signal produced by the integrator unit 96 at a positive (+) input, and a fixed reference voltage at a negative (−) input. The voltage comparator continuously compares the output signal produced by the integrator unit 96 to the reference voltage, producing a higher output voltage (e.g., corresponding to a digital logic ‘1’ level) when the output signal produced by the integrator unit 96 is greater than the reference voltage, and a lower output voltage (e.g., corresponding to a digital logic ‘0’ level) when the output signal produced by the integrator unit 96 is less than the reference voltage. (Of course, the digital logic values associated with high and low ouput voltages can be readily changed without significant effect on the circuit's operation.) The clock signal controls the latch such that when the clock signal is active (or asserted), the output of the comparator propagates through the latch. The latch stores the output of the comparator, and drives the stored output on an output terminal. When the clock signal is not active (or deasserted), the latch continues to drive the stored output on the output terminal.

Quantizer unit 80 has a single output terminal, which produces either the voltage corresponding to the digital logic ‘1’ level, or the voltage corresponding to the digital logic ‘0’ level, at the output terminal every cycle of the clock signal. The output of the quantizer unit 98 can be viewed as a pulse train having a relatively equal number of the higher voltage or “positive” pulses and the lower voltage or “negative” pulses per unit time when the position or deformation state of the sensing element 82 is near the null position or state of deformation, and a relatively higher number of positive than negative pulses per unit time when the position or deformation state of the sensing element 82 is below the reference position or state of deformation, and a relatively lower number of positive than negative pulses per unit time when the position or deformation state of the sensing element is above the null position.

As indicated in FIG. 6 and described above, the differential driver unit 102 resides in the in the quantized feedback loop 92. The differential driver unit 102 receives the one or more digital output signals produced by the quantizer unit 98 as digital input signal(s), and produces a differential voltage signal dependent upon the received input signal(s). The differential driver unit 102 provides the differential voltage signal to the conductive electrodes 114 (see FIG. 7) on the major surfaces 110 (see FIG. 7) of the piezoelectric sensing elements 86 that are not coupled to the flexible conductive sheet 84. The differential voltage signal opposes the differential voltage signal generated between the conductive electrodes 114 in response to the external force. As a result, a “restoring” force is generated within the piezoelectric sensing elements 86 to counter the motion or deformation caused by the external stimulus. By virtue of the quantized output signal produced by the quantizer, the quantized feedback loop exerts a quantized force on the sensing elements. Note that because the feedback signal is quantized, it is nearly always too high or too low to precisely counter the external stimulus, causing the sensing elements to oscillate. The discrepancy between the quantized feedback signal and the external stimulus controls the magnitude of the signal supplied to the integrator, which in turn controls the time required for the integrator output to cross the threshold and cause a positive pulse to emerge in the quantizer output stream. In this manner, the integrator serves to smooth out these discrepancies so that, on average, the position of the sensing element is returned to the null position. Even in the absence of an input stimulus, the quantized restoring force generated by or in response to the output of quantizer, tends to cause the sensing elements to oscillate symmetrically around the zero-input or null position of deformation.

In some embodiments, the differential driver unit 102 implements a circuit commonly referred to as a voltage level shifter. The output terminal of the differential driver unit 102 is connected to either a higher voltage level (e.g., a “+1” voltage), or to a lower voltage level (e.g., a “−1” voltage), dependent upon the voltage level (or digital logic level) of the digital output signal of the quantizer unit 98.

The output unit 104 receives the digital output signal produced by the quantizer unit 98 as an input signal, and one or more control signals (e.g., from the sensor telemetry unit 70 of FIGS. 4 and 5) as control input(s). Operating in response to the control signals from the sensor telemetry unit 70, the output unit 104 converts the one-bit digital output signal produced by the quantizer unit 98 to a digital output signal of the piezoelectric sensor 80 having multiple bits. Because the clock rate of the quantizer unit 98 is typically much higher than the bandwidth of the stimulus, the output unit 104 may implement, for example, a low-pass filter commonly referred to as a “decimating” filter that improves a signal-to-noise ratio.

The output unit 104 may include, for example, an n-bit binary counter that is latched and reset at periodic intervals. In this situation, the digital output signal of the piezoelectric sensor 80 may be the n-bit word produced by the counter. The counter receives a clock signal (e.g., from the sensor telemetry unit 70 of FIGS. 4 and 5) at a clock input, and the single digital output signal produced by the quantizer unit 98 at an enable input. When the output of the quantizer unit 98 is the voltage corresponding to the digital logic ‘1’ level, the counter is enabled and increments when the clock signal is active (or asserted). When the output of the quantizer unit 98 is the voltage corresponding to the digital logic ‘0’ level, the counter is disabled and does not increment when the clock signal is active (or asserted).

The counter may also receive a reset signal (e.g., from the sensor telemetry unit 70 of FIGS. 4 and 5) at a reset input, and a latch control signal (e.g., from the sensor telemetry unit 70) at a latch input. When the reset signal is active (or asserted), the internal count of the counter is set to ‘0.’ The latch control signal controls a latch such that when the latch control signal is active (or asserted), the multiple counter output signals propagate through the latch. The latch stores the multiple counter outputs, and drives the multiple counter outputs on a corresponding number of latch output terminals. When the latch signal is not active (or deasserted), the latch continues to drive the stored multiple counter outputs on the latch output terminals.

The clock signal provided to the counter (e.g., by the sensor telemetry unit 70 of FIGS. 4 and 5) may be, for example, a delayed or inverted version of the clock signal provided to the quantizer unit 98. The latch control signal, then the reset signal, may be asserted every 2̂n cycles of the clock signal. As a result, the output unit 104 updates the n-bit word digital output signal of the piezoelectric sensor 80 output every 2̂n cycles of the clock signal.

The output unit 104 may also implement any one of several more complex decimating filters known in the art. For example, various types of “sinc” filters are known in the art with response graphs that approximate an ideal rectangular shape in the time domain and a sinc function shape in frequency domain.

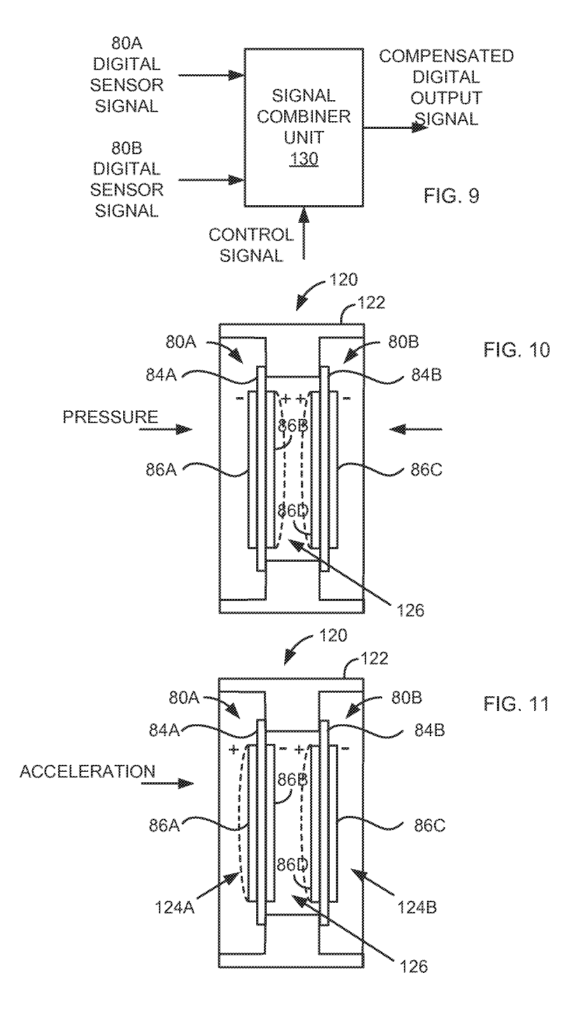

FIG. 8 is a side elevation view of a digital sensor 120 including a pair of the piezoelectric sensors 80 of FIG. 6, labeled “80A” and “80B” in FIG. 8. The digital sensor 120 also includes a signal combiner unit shown in FIG. 9 and described below. The digital sensor 120 may be configured to produce either a pressure compensated acceleration signal or an acceleration compensated pressure signal. The digital sensors 72 of FIGS. 4 and 5 may be, or include, the digital sensor 120.

In the embodiment of FIG. 8, the digital sensor 120 includes a housing 122. The piezoelectric sensors 80A and 80B are positioned within the housing 122, and on opposite sides of the digital sensor 120 such that the piezoelectric sensors 80A and 80B respond similarly to acceleration and oppositely to pressure.

In the embodiment of FIG. 8, the piezoelectric sensor 80A includes a pair of piezoelectric sensing elements 86A and 86B mounted on opposite sides of a flexible conductive sheet 84A, and the piezoelectric sensor 80B includes a pair of piezoelectric sensing elements 86C and 86D mounted on opposite sides of a flexible conductive sheet 84B. The piezoelectric sensor 80A is positioned in an outer recess 124A on one side of the housing 122, and the piezoelectric sensor 80B is positioned in an outer recess 124B on an opposite side of the housing 122. When the flexible conductive sheets 84A and 84B are positioned in the housing 122 as shown in FIG. 8, a cavity 126 exists in the housing 122 between the flexible conductive sheets 84A and 84B.

FIG. 9 is a diagram of a signal combiner unit 130 of the digital sensor 120 of FIG. 8. In the embodiment of FIGS. 8 and 9, the signal combiner unit 130 receives the digital output signals produced by the piezoelectric sensors 80A and 80B of FIG. 8, and a control signal (e.g., from the sensor telemetry unit 70 of FIGS. 4 and 5). The quantized feedback loop architecture of FIG. 6 may be used to generate each of these digital output signals. The signal combiner unit 130 uses the digital output signals of the piezoelectric sensors 80A and 80B to produce a compensated digital output signal. In some embodiments, the control signal configures the signal combiner unit 130 to either add or subtract the digital output signals of the piezoelectric sensors 80A and 80B to produce the compensated digital output signal.

If the signal combiner unit 130 is configured to add the signed versions of the n-bit word digital output signals of the piezoelectric sensors 80A and 80B, the (n+1)-bit compensated digital output signal is dependent upon acceleration of the digital sensor 120, and is substantially independent of a pressure acting on the piezoelectric sensors 80A and 80B (i.e., a pressure compensated acceleration signal). If the signal combiner unit 130 is configured to subtract the signed versions of the n-bit word digital output signals of the piezoelectric sensors 80A and 80B, the (n+1)-bit compensated digital output signal is dependent upon the pressure acting on the piezoelectric sensors 80A and 80B, and substantially independent of the acceleration of the digital sensor 120 (i.e., an acceleration compensated pressure signal).

FIG. 10 illustrates the deformation caused by pressure acting on the digital sensor 120. Note that the deformation of the piezoelectric sensors 80A and 80B produces signals of opposite signs. Conversely, FIG. 11 illustrates the deformation caused by acceleration acting on the digital sensor 120. Note that the deformation due to acceleration produces signals of the same sign. Because the sensors are carefully matched, the signals can be added or subtracted to compensate for pressure (when acceleration measurements are desired) or acceleration (when pressure measurements are desired).

Three instances of the digital sensor 120 may be combined such that acceleration sensing occurs along three orthogonal axes, thereby forming a 3-axis accelerometer. When such a 3-axis accelerometer is used as the 3-axis accelerometer 72A in the embodiment of the sensor unit 50 of FIG. 5, the separate digital hydrophone 72B is not required as any (or all) of the three instances of the digital sensor 120 may be configured to also sense surrounding pressure.

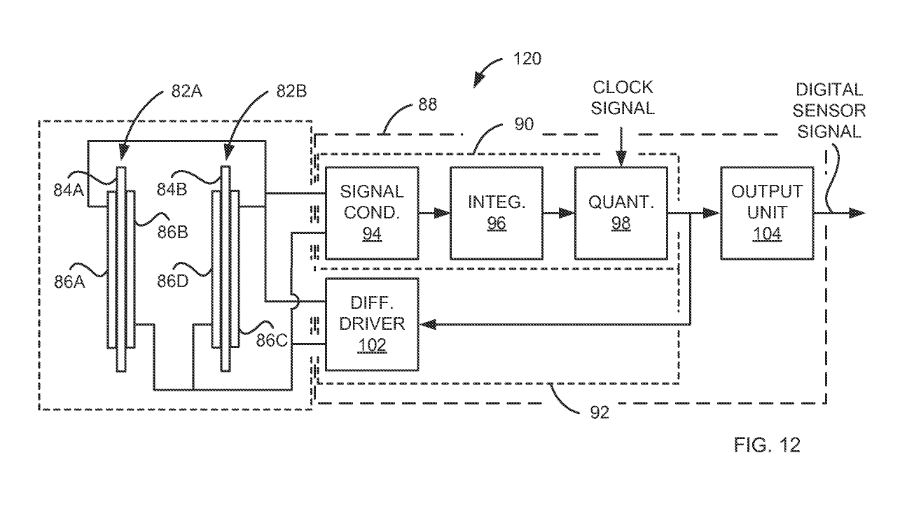

FIG. 12 is a diagram of a portion of an alternative embodiment of the digital sensor 120 of FIG. 6-9. Rather than having a separate digital transducer circuit for each sensing element 82A and 82B, with the digital outputs being added or subtracted, the embodiment of FIG. 12 employs a single digital transducer circuit with a single quantized feedback loop to control the combination of the sensing elements and convert their combined signal to a digital output signal. In the embodiment of FIG. 12, the digital sensor 120 includes a pair of the sensing elements 82 of FIG. 6, labeled “82A” and “82B” in FIG. 12, wired together to provide cancelation of the acceleration components of the individual sensing element responses.

As shown in FIG. 12, the sensing element 82A includes a pair of piezoelectric sensing elements 86A and 86B mounted on external and internal sides of a flexible conductive sheet 84A, respectively, and the sensing element 82B includes a pair of piezoelectric sensing elements 86C and 86D mounted on external and internal sides of a flexible conductive sheet 84B. The external piezoelectric sensing element 86A is electrically connected to the external piezoelectric sensing element 86C, and the internal piezoelectric sensing element 86B is electrically connected to the internal piezoelectric sensing element 86D. When pressure acts on the sensing elements 82A and 82B (see FIG. 10), the signals from the sensing elements add. When acceleration acts on the sensing elements (see FIG. 11), the signals from the matched sensing elements cancel. As a result, the digital sensor signal produced by the digital sensor 120 depends upon the pressure acting on the sensing elements 82A and 82B, and is substantially independent of the acceleration of the digital sensor 120 (i.e., an acceleration-compensated pressure signal).

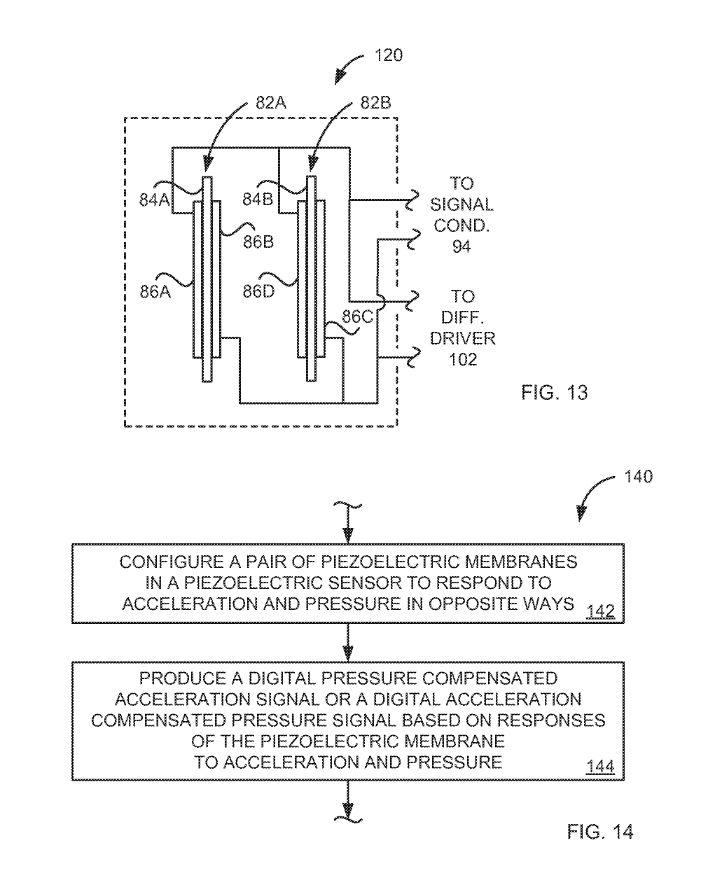

FIG. 13 is a diagram of a portion of the embodiment of the digital sensor 120 of FIG. 12 where the piezoelectric sensing elements 86A-86D of the sensing elements 82A and 82B have been electrically connected to produce a pressure compensated acceleration signal. In the embodiment of FIG. 13, the left-hand piezoelectric sensing element 86A of the sensing element 82A is electrically connected to the left-hand piezoelectric sensing element 86D of the sensing element 82B, and the right-hand piezoelectric sensing element 86B of the sensing element 82A is electrically connected to the right-hand piezoelectric sensing element 86C of the sensing element 82B. As a result, the digital sensor signal produced by the digital sensor 120 of FIG. 13 is dependent upon the on acceleration of the digital sensor 120, and substantially independent of the pressure acting on the sensing elements 82A and 82B (i.e., a pressure compensated acceleration signal).

FIG. 14 is a flowchart of one embodiment of a signal detection method 140. The method begins in block 142 with the configuration of a pair of piezoelectric membranes in a piezoelectric sensor. The membranes are configured to respond similarly to acceleration and oppositely to pressure as described above. The signals from the membranes are employed in block 144 to produce a digital pressure compensated acceleration signal or a digitial acceleration compensated pressure signal. To produce the digital signal, a quantized feedback signal may be applied to both membranes. Alternatively, each membrane may be driven with a respective quantized feedback signal. As explained previously, these quantized feedback signals enable an integrated digitization of the sensor signals, thereby obviating a separate digital to analog conversion step and offering the potential for a substantial power savings. The marine geophysical survey system 10 of FIGS. 1 and 2 may include a marine streamer cable having an array of digital piezoelectric sensors that each employ this signal detection method

Numerous variations and modifications will become apparent to those skilled in the art once the above disclosure is fully appreciated. For example, the foregoing description employed marine seismic surveys as a context for describing digital piezoelectric sensors and streamers. Other suitable applications include electromagnetic surveys or other systems employing marine streamers affected by motion or pressure variations. It is intended that the following claims be interpreted to embrace all such variations and modifications.

What is claimed is:

1. A sensor, comprising:
a pair of piezoelectric sensors configured to respond to acceleration and pressure in opposite ways;
a pair of digital transducer circuits each employing a quantized feedback path to obtain a digital sensor signal for a respective one of the piezoelectric sensors; and
a combiner circuit configured to combine the digital sensor signals, thereby producing a digital output signal comprising at least one of a pressure compensated acceleration signal and an acceleration compensated pressure signal.

2. The sensor as recited in claim 1, wherein each of the piezoelectric sensors comprises a sensing element configured to deform in response to an input stimulus, and to produce an electrical voltage between a pair of surfaces when deformed.

3. The sensor as recited in claim 1, wherein each of the sensing elements comprises a pair of piezoelectric elements mounted to opposite sides of a flexible conductive sheet.

4. The sensor as recited in claim 2, wherein each of the digital transducer circuits comprises forward circuitry coupled to the sensing element and configured to produce the digital sensor signal dependent upon the electrical voltage produced between the pair of surfaces.

5. The sensor as recited in claim 4, wherein the feedback circuitry is configured to generate a quantized feedback voltage dependent upon the digital sensor signal, and to apply the quantized feedback voltage between the pair of surfaces of the sensing element.

6. The sensor as recited in claim 4, wherein the forward circuitry comprises an integrator and a quantizer.

7. The sensor as recited in claim 1, wherein the feedback circuitry comprises a voltage level shifter.

8. The sensor as recited in claim 1, wherein the feedback circuitry comprises a differential voltage driver unit.

9. The sensor as recited in claim 1, wherein the combiner circuit is configured to either add or subtract the digital sensor signals to produce the digital output signal.

10. The sensor as recited in claim 1, wherein the sensor is positioned within a survey streamer.

11. A signal detection method that comprises:
configuring a pair of piezoelectric membranes in a piezoelectric sensor to respond to acceleration and pressure in opposite ways; and
producing at least one of a digital pressure compensated acceleration signal and a digital acceleration compensated pressure signal based on the piezoelectric membranes' responses to acceleration and pressure, wherein the producing includes applying a quantized feedback signal to at least one of the piezoelectric membranes.

12. The method of claim 11, wherein the quantized feedback signal is applied to both piezoelectric membranes.

13. The method of claim 11, wherein different quantized feedback signals are applied to the two membranes to provide respective digital sensor signals.

14. The method of claim 13, wherein the producing includes combining the respective digital sensor signals.

15. The method of claim 11, further comprising:
towing a marine streamer cable having an array of sensors that includes the piezoelectric sensor;
periodically triggering an energy source to stimulate response signals from subsurface formations; and
recording the compensated digital output signals as the marine streamer cable acquires response signal measurements.

16. A sensor that comprises:
a pair of piezoelectric sensors configured to respond to acceleration and pressure in opposite ways, the pair of sensors being coupled together to provide at least one of pressure and acceleration compensation;
at least one digital transducer circuit employing a quantized feedback path to the pair of piezoelectric sensors to obtain at least one of a digital pressure compensated acceleration signal and a digital acceleration compensated pressure signal.

17. The sensor of claim 16, wherein the quantized feedback path applies a quantized feedback voltage to each of the pair of piezoelectric sensors.

18. The sensor of claim 17, wherein the quantized feedback path includes a binary voltage level shifter.

19. The sensor of claim 18, wherein the digital transducer circuit includes forward circuitry having an integrator and a quantizer.

20. The sensor of claim 16, wherein the feedback circuitry comprises a differential voltage driver unit.

21. The sensor of claim 16, wherein the sensor is positioned within a survey streamer.
